(19) United States
(12) Patent Application Publication
(10) Pub. No.: US 2019/0030590 A1
(43) Pub. Date: Jan. 31, 2019

(54) FIBER-REINFORCED CASTING WAX PRODUCT

(71) Applicant: M. Argueso & Co., Inc., Muskegon, MI (US)

(72) Inventors: Alfred Peter KAULIUS, JR., Muskegon, MI (US); Harvey FIELDER, Muskegon, MI (US)

(21) Appl. No.: 16/073,512

(22) PCT Filed: Mar. 1, 2016
(86) PCT No.: PCT/US16/20156

§ 371 Date: Jul. 27, 2018

(51) Int. Cl. B22C 7/02; C08L 91/06; C08K 7/02

(52) U.S. Cl. CPC B22C 7/02; C08L 91/06; C08K 2201/016; C08K 2201/003; C08K 2201/004; C08K 7/02

(57) ABSTRACT

A casting wax product including a casting wax and fibers distributed within the casting wax. The casting wax may be a standard casting wax. The currently preferred volume percent of the fibers is no more than 5%. The currently preferred aspect ratio of the fibers is between 10:1 and 25:1. The preferred fiber material is organic. Among other qualities, the casting wax product has improved slump resistance, improved rigidity, and improved strength.

### BACKGROUND OF THE INVENTION

The present invention relates to investment casting, and more particularly to casting waxes used in investment casting.

Investment casting is an industrial process based on, and sometimes still called, lost-wax casting. Investment casting enables the production of components with accuracy, repeatability, versatility, and integrity in a variety of metals and high-performance alloys. Metals that can be used in investment casting include for example stainless steel alloys, brass, aluminum, carbon steel, and superalloys (e.g. nickel and cobalt based). Investment casting can produce complicated shapes that would be difficult or impossible using other casting techniques. Consequently, investment casting can reduce the need for secondary machining by providing castings to shape.

Casting waxes are used in investment casting. A wide variety of casting waxes are available to provide a variety of balances of characteristics. A continual need exists for new casting waxes providing enhanced balances of characteristics.

### SUMMARY OF THE INVENTION

The present invention provides an improved casting wax product including (1) a casting wax and (2) fibers distributed within the casting wax. The casting wax may be any known casting wax. The fibers are preferably organic in nature.

The casting wax product of the present invention provides improved slump resistance, rigidity, and overall strength. The product is dimensionally stable, has low thermal expansion, and has acceptable viscosity and burnout behavior.

These and other advantages and features of the invention will be more fully understood and appreciated by reference to the description of the current embodiments and the drawings.

### BRIEF DESCRIPTION OF THE DRAWINGS

FIG. 1 is a graph illustrating the stiffness of an embodiment of the casting wax product in comparison to an industry standard casting wax.

FIG. 2 is a graph illustrating the strength of an embodiment of the casting wax product in comparison to an industry standard casting wax.

FIG. 3 is a graph illustrating the results of an accelerated weighted slump test of an embodiment of the casting wax product in comparison to an industry standard casting wax.

FIG. 4 is a picture of the setup for an accelerated, weighted slump test of a casting wax.

FIG. 5 is a graph illustrating the results of an accelerated, weighted slump test of an embodiment of the casting wax product in comparison to other casting waxes.

FIG. 6 is a graph illustrating the results of the accelerated, weighted slump test of embodiment of the product having varying degrees of fiber additions.

FIG. 7 is a graph illustrating the maximum load of several embodiments of the casting wax product including fibers of different aspect ratios.

FIG. 8 is a graph illustrating the Young's modulus of several embodiments of the casting wax product including fibers of different aspect ratios.

### DESCRIPTION OF THE CURRENT EMBODIMENTS

The casting wax product of the present invention includes two components. The first component is a casting wax, which may be an industry-standard casting wax comprising a mixture of multiple thermoplastic materials. The second component is organic fibers.

The casting wax of the casting wax product may be any conventional or industry standard casting wax now known or later developed. The casting wax may be virgin or recycled, or a combination of virgin and recycled. One sample casting wax comprises 15-30% paraffin wax, 10-25% microcrystalline wax, and 35-60% hydrocarbon resin. The casting wax may also contain other additives in the 0-10% range, including, but not limited to fatty acids, polyethylene, ethyl-vinyl-acetate and copolymers thereof, and polymerized alkenes. Another sample casting wax is that sold under the designation CERITA® 30-80 by Paramelt Argueso, the Applicant of the present application.

The fibers distributed within the casting wax may be of any material now known or later developed. Preferably, the fibers are organic fibers. Fibers that have been used with good results include those of polyester, polyamide (nylon), and rayon.

The fibers used in the embodiments included in the present application are fabricated of nylon and have an average diameter of approximately 15 microns. These fibers are sometimes referred to as “nylon flock.” Although this is the diameter of the current embodiments, it is believed that diameters with a relatively wide range may be suitable. Tested diameters to date have been in the range of 6 microns to 20 microns; and it is believed that fibers in the range of 10 microns to 18 microns are preferred.

In the current embodiments, the fibers (i.e. the fibers having an average diameter of approximately 15 microns) have an average length of approximately 0.25 mm (millimeters). Although this is the average length of the current embodiment, it is believed that lengths with a relatively wide range may be suitable. And specifically it is believed that fibers having lengths in the range of approximately 0.1 mm to approximately 1 mm would be effective. Preferably, each embodiment includes fibers that are relatively uniform in length. It is believed that fibers of varying length could be used in a single product.

Based on the above-described diameter and lengths of the disclosed embodiments, the aspect ratio of the fibers ranges from approximately 5:1 to approximately 55:1. As will be appreciated from FIG. 8, discussed at greater length below, an aspect ratio of approximately 15:1 (and specifically 16.7:1) provides a relatively high Young's modulus and therefore is believed to be particularly advantageous. It appears that fibers having aspect ratios in the range of 15:1 (corresponding to a fiber length 0.225 mm) to 20:1 (corresponding to a fiber length of 0.300 mm provide advantageous results. The maximum tested aspect ratio is approximately 66.7:1 (based on a fiber diameter of 15 microns and a fiber length of 1 mm).

The loading of the fibers distributed within the casting wax preferably is selected to provide a desired balance between slump resistance, rigidity, and viscosity. Relatively high loading of fibers may result in a product of undesirably high viscosity, which may be difficult to use. Relatively low loading levels of fibers may result in a product with insufficient slump resistance and/or rigidity.

Preferably, the fibers comprise less than approximately 5% by volume of the casting wax product. Further preferably, the fibers comprise 2% to 3% by volume of the casting wax product. And the fibers comprise 2.5% by volume of the disclosed embodiments. The specific volume of fiber will depend on a variety of factors, including the specific casting wax, the fiber material, and the fiber size.

While dimensional, loading, and other numeric information is provided in this specification, it is noted and perhaps indeed expected, that fibers having dimensions and other numeric information outside the preferred ranges may perform satisfactorily and indeed may perform more advantageously. Therefore, the present invention should not be interpreted to depend on the specific dimensions and other numeric information provided. However, the disclosed preferences and the examples provided below are currently believed to be the best modes of practicing the invention.

The casting wax product comprising a fiber-reinforced casting wax provides improved slump resistance, rigidity, and overall strength. The product is dimensionally stable, has low thermal expansion, and has acceptable viscosity and burnout behavior. Burnout is the final wax evacuation from the ceramic shell prior to metal pouring. Accordingly, the casting wax product is particularly well-suited for, but not limited to, gating (also known as runner or sprue) applications and pattern applications.

The fibers included in casting wax products created and evaluated (1) have been fabricated of polyester, polyamide (nylon), and rayon, (2) have had an average diameter of 15 microns (and in the range of 5 microns to 20 microns), (3) have had lengths in the range of 0.25 mm to 1 mm, and (4) have had aspect ratios in the range of 5:1 to 55:1. Indeed, aspect ratios of up to 100:1 have demonstrated improvement.

In selecting fiber products for reinforcement of investment casting wax products, the following characteristics of the fiber are advantageous: low ash, high melting point, high wettability in base wax, toughness, and low cost. Other characteristics, currently believed to be secondary, such as absorbency and elongation, will affect performance, as well.

Casting wax products fabricated of a standard 30-80 casting wax and including 2.5% by volume of nylon fiber having a diameter of 19 millimeters has good viscosity and burnout behavior, as well as providing improved mechanical performance.

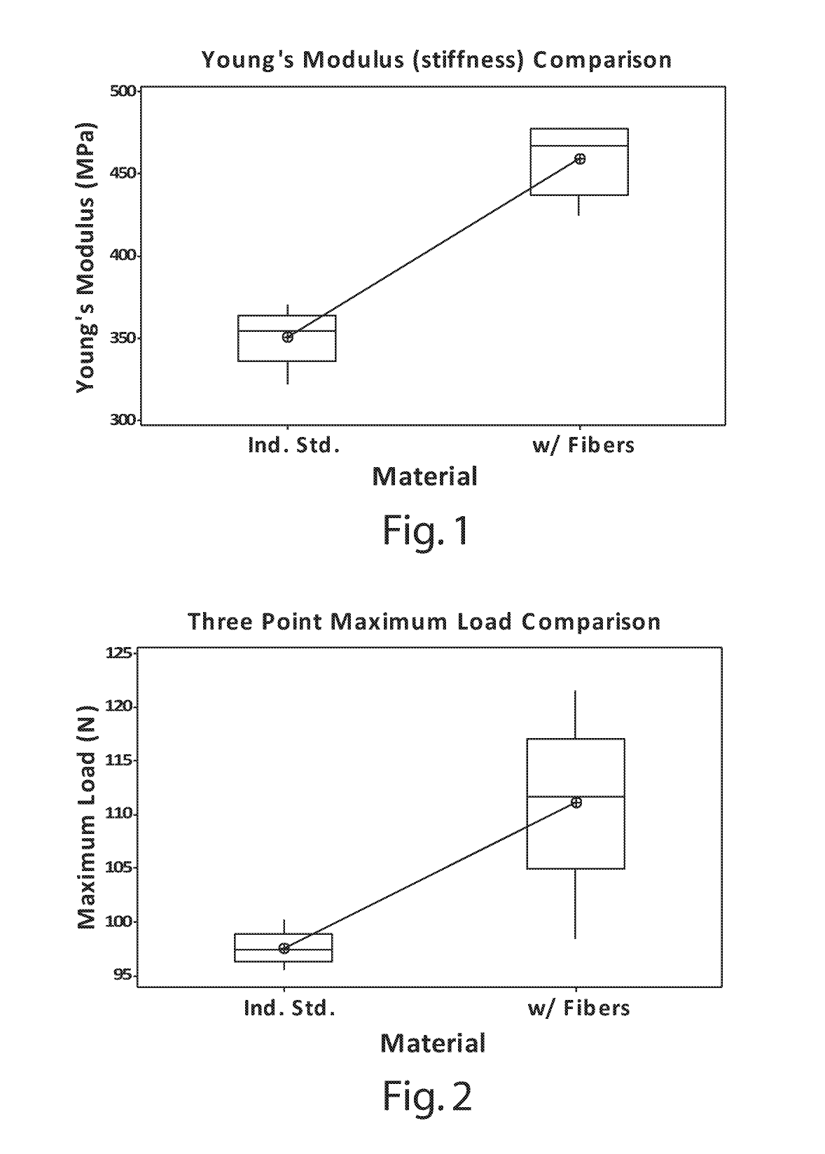

FIG. 1 illustrates the stiffness of this embodiment of the casting wax product in which the aspect ratio of the fibers is approximately 15:1. As will be seen, this product provides a significant improvement in stiffness versus a standard casting wax. Young's modulus is the relationship between stress (force per unit area) and strain (proportional deformation) in a material. The higher the Young's modulus, the stiffer the material.

FIG. 2 illustrates the strength of this embodiment. As will be seen, this product provides a significant improvement in strength versus a standard casting wax. The three-point maximum load is the maximum stress withstood by the material for a given configuration before it breaks or permanent deformation occurs. The higher the maximum load, the stronger the material.

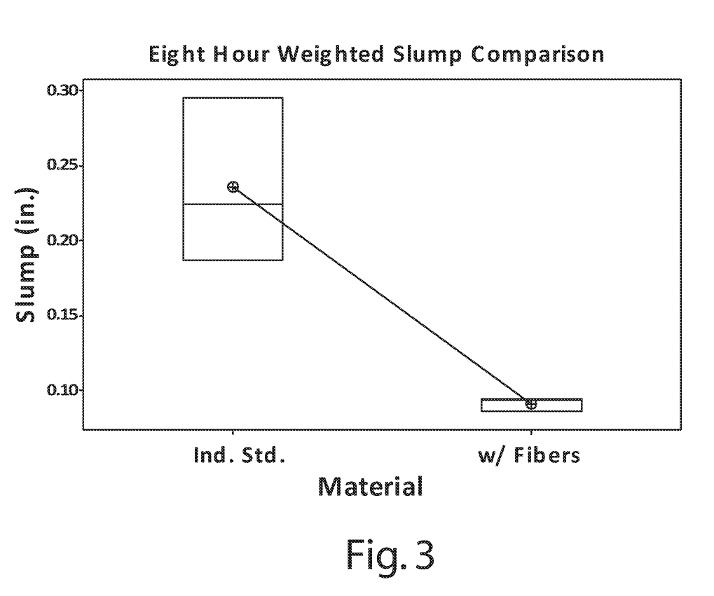

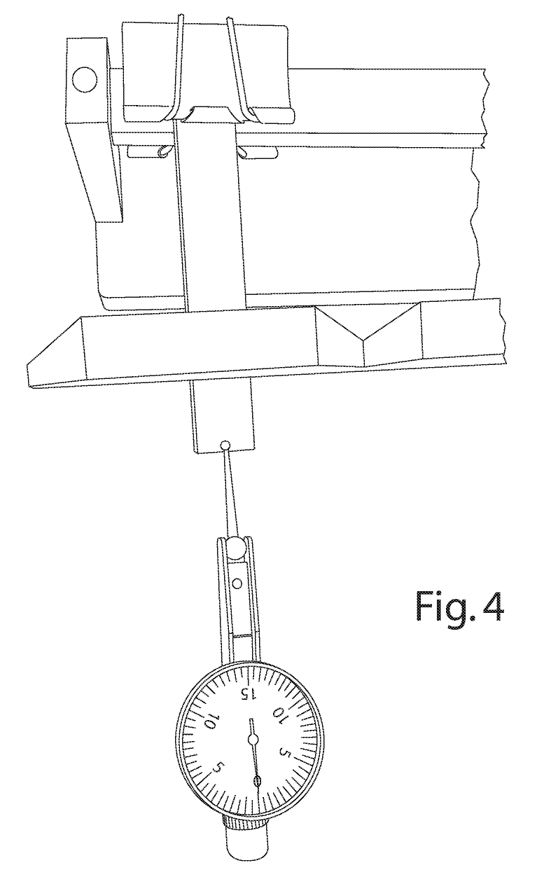

FIG. 3 illustrates the significant improvement in the accelerated, weighted slump test of this product over a standard casting wax. FIG. 4 shows the setup for the accelerated, weighted slump test. The test includes supporting a test bar of approximate dimensions 0.7″×0.5″×5.0″ from one end and placing a weight on the cantilevered portion. The slump is measured as the vertical deflection over time of the unsupported tip.

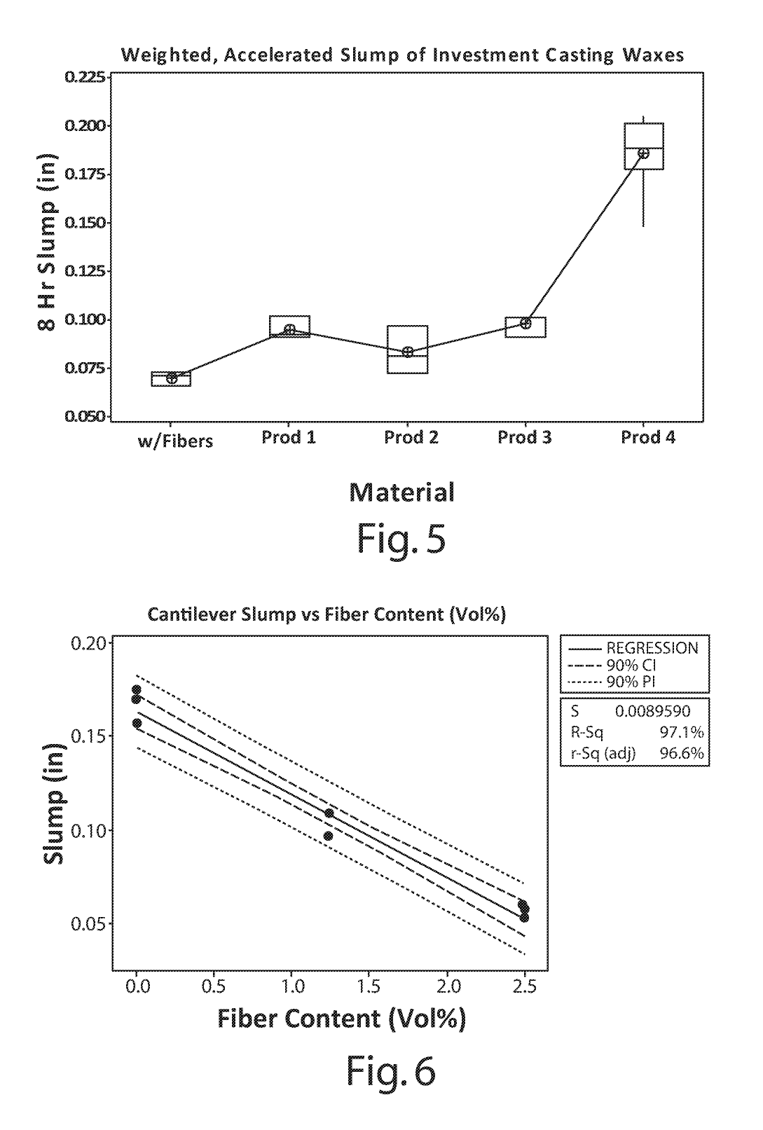

FIG. 5 illustrates the accelerated, weighted slump test results of this product (denominated “w/Fiber”) in comparison to other standard investment casting waxes that do not include any fiber addition. For this test, a lower value (i.e. a lesser slump) indicates a better result. The tested waxes (in addition to the described embodiment) are as follows:
1. Prod. 1: A 100% reclaimed (used) casting wax which has been cleaned and filtered for re-use.
2. Prod. 2: A typical virgin gating wax used in aerospace casting.
3. Prod. 3: A reclaimed gating material with virgin additions for aerospace casting.
4. Prod. 4: A reclaimed gating wax used in aerospace casting.

The 2.5% loading currently appears to provide a highly desirable combination and/or balance of physical properties without significant degradation in viscosity (i.e. flow characteristics).

The following three tables summarize the performance of casting wax products including standard casting waxes and various fiber products at various loadings. In these products, the fibers had diameters between 10 and 15 microns and lengths between 250 and 290 mm, with corresponding aspect ratios of 15:1 to 90:1.

TABLE 1
Weighted, Accelerated Cantilever Slump

| | | | Fiber | Fiber | | |
|---|---|---|---|---|---|---|
| Base | Fiber | Fiber | Length | Diameter | Slump | |
| Material | % | Type | (mm) | (μ) | (in) | Comment |
| Industry | 0 | N/A | N/A | N/A | 0.235 | Baseline |
| Standard | | | | | | |
| Industry | 2.5 | Nylon | 0.25 | 15 | 0.091 | 61% |
| Standard | | | | | | Improvement |
| | | | | | | over baseline |
| Industry | 2.5 | Poly- | 0.25 | 12 | 0.097 | 59% |
| Standard | | ester | | | | Improvement |
| | | | | | | over baseline |
| Industry | 2.5 | Rayon | 0.89 | 10 | 0.103 | 56% |
| Standard | | | | | | Improvement |
| | | | | | | over baseline |

TABLE 2
Three-Point Bend Maximum Load

| | | Fiber | Fiber | | |
|---|---|---|---|---|---|
| Fiber | Fiber Length | Diameter | Loading | Maximum | |
| Type | (mm) | (μ) | (Vol %) | Load (N) | Comments |
| None | N/A | N/A | 0 | 97 | |
| Nylon | 0.25 | 15 | 2.5 | 111 | 14% |
| | | | | | Improvement |
| Rayon | 0.25 | 12 | 2.5 | 116 | 20% |
| | | | | | Improvement |

TABLE 3
Young's Modulus (Stiffness Measurement)

| | Fiber | Fiber | | Young's | |
|---|---|---|---|---|---|
| Fiber | Length | Diameter | Fiber Loading | Modulus | |
| Type | (mm) | (μ) | (Vol %) | (MPa) | Comments |
| None | N/A | N/A | 0 | 351 | |
| Nylon | 0.25 | 15 | 2.5 | 459 | 31% |
| | | | | | Improvement |
| Rayon | 0.25 | 12 | 2.5 | 451 | 28% |
| | | | | | Improvement |

FIG. 6 illustrates the cantilever slump test results at various loadings of the described nylon fibers having a diameter of approximately 19 microns and a length of approximately 1 mm.

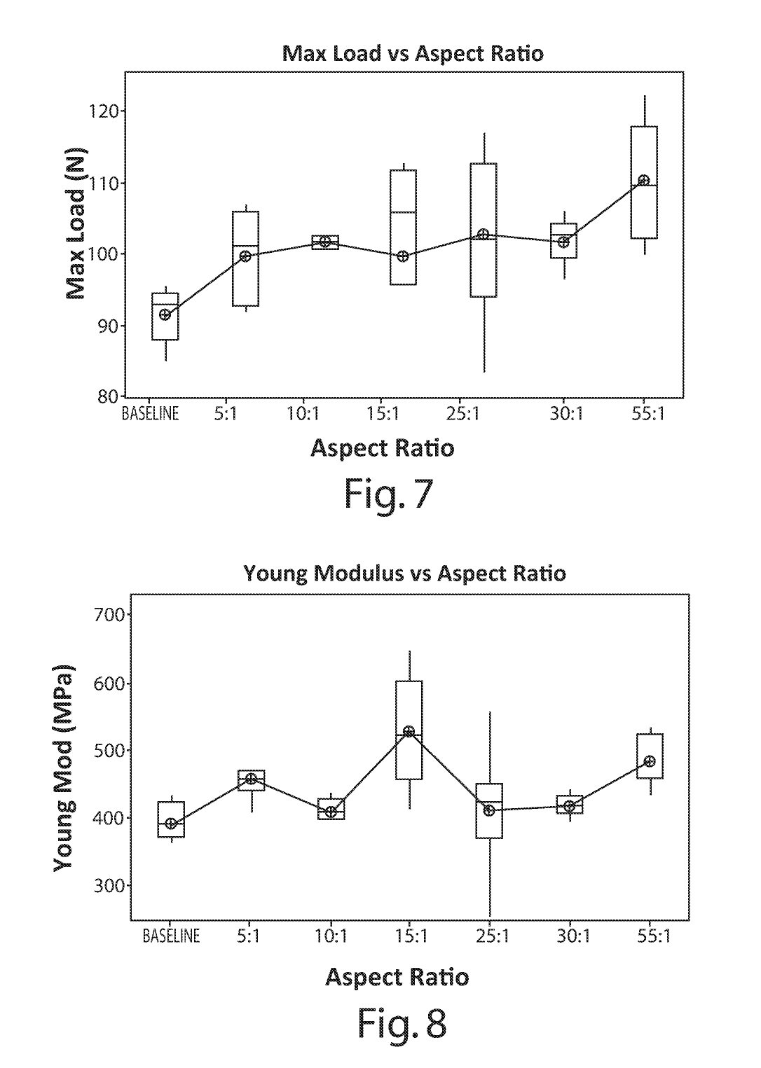

FIGS. 7 and 8 show the maximum load and the Young's modulus, respectively, for embodiments of the casting wax product that the nylon fiber (i.e. having a diameter of approximately 19 microns) of varying aspect ratios.

As will be appreciated from FIG. 7, the maximum loads of the embodiments with fiber aspect ratios in the range of 5:1 to 30:1 appear to be largely independent of the aspect ratio. These maximum loads range between approximately 100 N and approximately 102 N. These maximum loads are markedly higher than the “Baseline” (i.e. casting wax without fiber) maximum load of approximately 92 N. The maximum load of the embodiment with a fiber aspect ratio of 55:1 is significantly higher (at approximately 109 N) than all of the other maximum loads. This may be attributable to entanglement (e.g. mechanical interlocking) of the longer fibers.

As will be appreciated from FIG. 8, the Young's modulus of the embodiment with a fiber aspect ratio of 15:1 is the highest Young's modulus of all the embodiments.

Considering FIGS. 7 and 8, it is believed that casting wax products including fibers having an aspect ratio in the range between 10:1 and 25:1 provide a desired balance of characteristics; and a casting wax product including fibers having an aspect ratio of approximately 15:1 provides a very desired balance of characteristics.

The currently tested applications have been to improve the slump and stiffness of gating waxes. Depending upon the assembly configuration and the assembly technique, stiffness can be a key characteristic for wax assembly performance. The assembly configuration and technique include the actual assembly performance and through the shell investment process. In addition to gating wax applications, the addition of fibers is believed to be advantageous in pattern wax applications where dimensional stability is highly important. Examples include long, thin, solid airfoil applications and large, marine propeller applications. It is believed that a wide variety of organic fibers have the capability to improve the mechanical properties of the casting wax products.

In addition to the fiber types tested to date (polyester, nylon, and rayon), other organic materials such as acrylic, cotton, wool, polyethylene, and polypropylene may provide similar improvements. However, anticipated issues with these materials include relatively high ash, fiber size, and/or temperature limitations. It is believed that variations of the fiber length and diameter may produce casting wax products having similar, acceptable, and/or improved results. Such variations beyond those disclosed in this specification have not been created or tested.

Fiber volumes in excess of 5% by volume have been found to be undesirably viscous. Testing of such products has revealed (1) 10% loading of the polyethylene fiber resulted in a product of undesirably high viscosity; (2) greater than 5% loading of the polyethylene fiber also resulted in a product of undesirably high viscosity; and (3) greater than 5% loading of the nylon fiber resulted in a product of undesirably high viscosity.

The above descriptions are those of current embodiments of the invention. Various alterations and changes can be made without departing from the spirit and broader aspects of the invention as defined in the appended claims, which are to be interpreted in accordance with the principles of patent law including the doctrine of equivalents.

This disclosure should not be interpreted as an exhaustive description of all embodiments of the invention or to limit the scope of the claims to the specific elements illustrated or described in connection with these embodiments. For example, and without limitation, any individual element of the described invention may be replaced by one or more alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative.

The invention is not limited to the details of operation or to the details of construction and the arrangement of the components set forth in the above description or illustrated in the drawings. The invention may be implemented in various other embodiments and practiced or carried out in alternative ways not expressly disclosed herein.

The phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

The disclosed embodiment includes a plurality of features that are described in concert and that might cooperatively provide a collection of benefits. The present invention is not limited to only those embodiments that include all of these features or that provide all of the stated benefits.

Any reference to claim elements in the singular, for example, using the articles “a,” “an,” “the” or “said,” is not to be construed as limiting the element to the singular.

Directional terms, such as “front,” “back,” “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation.

The embodiments of the invention in which an exclusive property or privilege is claimed are defined as follows:

1. A casting wax product comprising:
a casting wax; and
a plurality of fibers within the casting wax.

2. A casting wax product as defined in claim 1 wherein the fibers are organic fibers.

3. A casting wax product as defined in claim 1 wherein the fibers comprise no more than approximately 5% by volume of the product.

4. A casting wax product as defined in claim 3 wherein the fibers comprise 2% to 3% by volume of the product.

5. A casting wax product as defined in claim 2 wherein the organic fibers include at least one of polyester, polyamide, and rayon.

6. A casting wax product as defined in claim 1 wherein the length of the fibers is less than or equal to approximately 1 mm.

7. A casting wax product as defined in claim 1 wherein the diameters of the fibers are in the range of 6 microns to 20 microns.

8. A casting wax product as defined in claim 1 wherein the aspect ratio of the fibers is between 5:1 and 55:1 inclusive.

9. A casting wax product as defined in claim 8 wherein the aspect ratio of the fibers is between 15:1 and 20:1 inclusive.

10. A method of manufacturing a casting wax product comprising:
providing a casting wax; and
reinforcing the casting wax with a plurality of fibers.

11. A method as defined in claim 10 wherein the fibers are organic fibers.

12. A method as defined in claim 10 wherein the fibers comprise no more than approximately 5% by volume of the casting wax product.

13. A method as defined in claim 12 wherein the fibers comprise 2% to 3% by volume of the casting wax product.

14. A method as defined in claim 11 wherein the organic fibers include at least one of polyester, polyamide, and rayon.

15. A method as defined in claim 10 wherein the length of the fibers is less than or equal to approximately 1 mm.

16. A method as defined in claim 10 wherein the diameters of the fibers are in the range of 6 microns to 20 microns.

17. A method as defined in claim 10 wherein the aspect ratio of the fibers is between 10:1 and 25:1 inclusive.

18. A method as defined in claim 1 wherein the aspect ratio of the fibers is between 15:1 and 20:1 inclusive.
